(19) United States
(12) Patent Application Publication
(10) Pub. No.: US 2010/0316887 A1
(43) Pub. Date: Dec. 16, 2010

(54) Sheet product having an outer surface optimized for anodization

(76) Inventor: Horst Dwenger, Goettingen (DE)

Correspondence Address: Christopher C. Dunham;c/o Cooper & Dunham LLP, 30 Rockefeller Plaza, New York, NY, 10112, US

(21) Appl. No.: 12/802,627

(22) Filed: Jun. 9, 2010

Related U.S. Application Data
(60) Provisional application No. 61/268,860, filed on Jun. 16, 2009.

(51) Int. Cl. B32B 15/01

(52) U.S. Cl. 428/654

(57) ABSTRACT

The exemplary embodiments relate to an aluminum architectural sheet product in which a clad layer is applied to at least one side of a core layer. Preferably, the core layer is made of an alloy selected from the AA5XXX series alloys with a magnesium content greater than 3 weight %, and the clad layer (or each clad layer) is made of an alloy selected from alloys AA5005, AA5205, AA5052, AA5252 and AA5005A. The product may be provided with an anodic film on one or both faces and the film(s) may be covered with one or more layers, e.g. of paint.

### CROSS-REFERENCE TO RELATED APPLICATION

This application claims the priority right of prior co-pending provisional patent application Ser. No. 61/268,860 filed on Jun. 16, 2009 by applicants named herein. The entire contents of provisional application 61/268,860 are specifically incorporated herein by this reference.

### BACKGROUND OF THE INVENTION

1. Field of the Invention

The present invention relates to aluminum architectural sheet products, and the like. More particularly, the invention relates to products of this kind intended to be anodized at an outer surface thereof.

2. Background Art

Aluminum sheet products are often used for architectural purposes, such as building exteriors, interior decor and lighting fixtures. Aluminum sheet offers the designer a range of aesthetic possibilities along with ease of manufacture, a relatively good strength-to-weight ratio and resistance to weathering so that the product lasts for years and is inexpensive to maintain. Sheet products of this kind may also be readily formed into, for example, corrugated shapes. A typical application is as façade or cladding materials for tall buildings. Currently all architectural sheet of this nature is made from single alloy sheet compositions, or single alloy sheet.

There are various ways to prepare the surface of such architectural sheet for use. The surface may be anodized and subsequently coated with primers and a paint layer, the paint having been formulated to a set gloss (light reflection) value. Architectural sheet may also be provided in a bare condition, i.e. a condition where no further coating layer is applied to the anodized surface. Anodized sheet can also be provided with different surface colours to enhance aesthetic appeal. Alternatively, the aluminum surface may first be conversion coated using a typical chromate pre-treatment process and then painted with the same formulated paints. Conversion processes like this tend to be environmentally unfriendly because of the materials employed.

Composite, or layered, materials are known within the aluminum industry and, typically, find uses in applications in aerospace or as brazing sheet. In brazing sheet, the core alloy is typically an alloy from the AA3XXX series of alloys and, typically, the clad layer is a AA4XXX series alloy. For an understanding of the number designation system most commonly used in naming and identifying aluminum and its alloys see “International Alloy Designations and Chemical Composition Limits for Wrought Aluminum and Wrought Aluminum Alloys”, published by The Aluminum Association, revised April 2004; the disclosure of which is incorporated herein by reference.

The AA5XXX series of alloys covers those aluminum alloys in which magnesium is the main alloying element. The April 2004 register lists 96 designated compositions for the AA5XXX series alloys.

The AA5XXX series alloys are generally considered to be non-heat-treatable alloys, i.e. their strength does not depend on heating procedures. They develop their strength from solid-solution strengthening, from second phase intermetallic particles and through grain refinement. Strength is also developed in these alloys through strain hardening during cold working.

Anodizing is the process by which an oxide film is formed on the surface of aluminum (acting as the anode within an electrolytic cell) under the action of an applied current in a conducting electrolyte. A wide range of anodizing processes are well established in the aluminum industry and have been used to deposit oxide layers of many different kinds (see, for example, the ASM Specialty Handbook “Aluminum and Aluminum Alloys”, pages 462-472; the disclosure of which is incorporated herein by reference). Some anodizing processes are used as pre-treatment methods to deposit thin anodic layers of around 50-200 nm before subsequent coating applications; others are used to deposit hard oxide layers many microns thick of the kind more suited for use in architectural and industrial applications where the anodic oxide layer provides an increase in corrosion resistance. An anodized surface provides other significant benefits including resistance to fingerprint marking, a higher scratch resistance compared with painted surfaces, resistance to high temperatures, color stability (i.e. does not deteriorate due to UV exposure), and non-toxicity.

Some 5XXX series alloys are already known for use as architectural anodizable sheet, such as the alloys AA5005, AA5205, AA5050, AA5052, AA5357, AA5457 and AA5657. Since the magnesium content in these alloys needs to be low to provide good anodizing quality, they have inferior mechanical properties when compared with other 5XXX series alloys.

There is a need to provide products possessing good mechanical properties, in particular high strength, in combination with high quality surface anodizing capability.

### SUMMARY OF THE EXEMPLARY EMBODIMENTS

Exemplary embodiments of the invention provide an aluminum architectural sheet product which comprises a composite structure having a core layer and at least one clad layer, wherein the core layer is made of an alloy selected from the is AA5XXX series alloys where the magnesium content is above 3 weight %, and the at least one clad layer is made of an alloy selected from the group consisting of AA5005, AA5005A, AA5205, AA5052 and AA5252.

For the sake of completeness, the contents of the five alloys named above are set out in Table 1 below.

TABLE 1

| Alloy | Si | Fe | Cu | Mn | Mg | Cr | Zn |
|---|---|---|---|---|---|---|---|
| AA5005 | 0.3 | 0.7 | 0.10 | 0.20 | 0.5-1.1 | 0.1 | 0.25 |
| AA5005A | 0.3 | 0.45 | 0.05 | 0.15 | 0.7-1.1 | 0.10 | 0.20 |
| AA5205 | 0.15 | 0.7 | 0.03-0.10 | 0.10 | 0.6-1.0 | 0.10 | 0.05 |
| AA5052 | 0.25 | 0.40 | 0.10 | 0.10 | 2.2-2.8 | 0.15-0.35 | 0.10 |
| AA5252 | 0.08 | 0.10 | 0.10 | 0.10 | 2.2-2.8 | | 0.05 |

It should be noted in connection with Table 1 that a single figure provided for an element means that the element may be absent or present in an amount up to the value shown by the figure as a maximum. The values shown are in weight percent. The balance is aluminum.

Of the listed alloys, the maximum content of Mg is 2.8 wt. % (alloys AA5052 and AA5252) and the minimum is 0.5 wt. % (for alloy AA5005).

In one embodiment, the composite structure comprises three layers with a core layer of the indicated kind positioned between two outer clad layers of the indicated kind. The two clad layers may be of the same or of a different composition.

The composite product may comprise just two layers. In the normal use of the terms within the industry, the clad layer (sometimes referred to as the outer layer) is usually the term given to that layer which dictates surface characteristics or is exposed to the atmosphere or the eye of the observer. The clad layer is usually, but not necessarily, thinner than the core layer. It will be apparent that the term “core” does not imply that there are clad layers on both sides of the core layer.

### BRIEF DESCRIPTION OF THE DRAWINGS

Exemplary embodiments are described in more detail in the description below, in which reference is made to the accompanying drawing wherein:

FIG. 1 a schematic cross-section of an exemplary embodiment showing a two-layer structure;

FIG. 2 is a cross-section similar to that of FIG. 1 but showing a structure formed in the Example below; and

FIG. 3 is a graph showing a plot of yield strength, UTS and elongation to failure vs. rolling reduction for the exemplary embodiment, as tested.

### DETAILED DESCRIPTION OF EXEMPLARY EMBODIMENTS

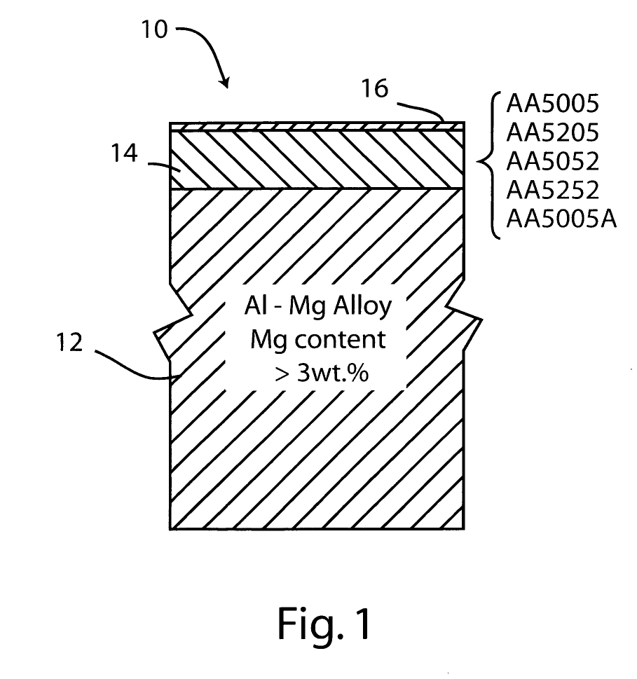

FIG. 1 represents a basic exemplary embodiment of an anodized composite structure 10 in which there is core layer 12, a single clad layer 14, and an anodized film 16 on the outer surface of the clad layer.

The primary purpose of the core layer 12 is to influence (or establish) the bulk mechanical properties of the overall sheet product or to absorb a high amount of recycled (and therefore less expensive) material. The clad layer 14 may be quite thin as its purpose is solely to provide an alloy at the surface that undergoes a high quality anodization. As stated, there may be a clad layer on each side of the core layer, and both clad layers may carry an anodic film.

The alloys of the core layer are selected to be inherently stronger than the alloys used in the at least one clad layer. For example, aluminum alloys containing 3 wt. % Mg or more have been found to be suitable for the core because of their good tensile strength. These alloys are generally included in the AA5XXX series. The AA5XXX series alloys suitable for use as a core layer 12 include the alloys selected from the group consisting of AA5154, AA5254, AA5654, AA5754, AA5056, AA5456, AA5556, AA5082, AA5182, AA5083, AA5383, AA5086 and AA5186. The preferred AA5XXX series core layer alloys are those selected from the group consisting of AA5056, AA5456, AA5083, AA5383, AA5182 and AA5754. All of these alloys have an Mg content of more than 3 wt. %.

Although the invention contemplates a group of five alloys for the at least one clad layer, particular improvements may be achieved in the anodizing quality by selecting the AA5205 alloy, which has low Fe and Si levels, for the clad layer(s) 14.

The product according to exemplary embodiments may provide the same quality of anodizable surface finish as currently available in current monolithic materials but with additional mechanical strength. This means that thinner and lighter sheet can be used for the same applications, providing weight savings and making installation easier. The exemplary embodiments also allow larger sheet sections to be used as façade panels because they have greater structural integrity. The exemplary embodiments may be provided in the bare condition, anodized only, or they can be treated with further coating layers through application of one or more of adhesion promoters, primers, additional paint layers and the like.

The exemplary embodiments can be fabricated by conventional methods known to those in the aluminum industry. For example, the product can be made by a traditional roll bonding approach where the layers are initially cast as separate ingots, homogenized and hot rolled to an intermediate thickness, then hot or cold rolled together to form the composite structure, followed by further rolling as necessary. As is known to the skilled person, various heat treatment steps may be incorporated within this process if necessary, such as intermediate anneals or partial final anneals.

An alternative method of manufacture involves casting the two or more layers at the same time or in the same casting operation to form a single ingot having distinct compositional layers. Such methods are also well known in the aluminum industry and are described in PCT patent publications WO 04/112992 or WO 07/098583, the disclosures of which are incorporated herein by reference. Once the composite ingot has been cast, it can be processed in the conventional manner and process steps may include homogenization, hot and cold rolling, together with other standard manufacturing steps and heat treatments as deemed necessary by the skilled person.

### Examples

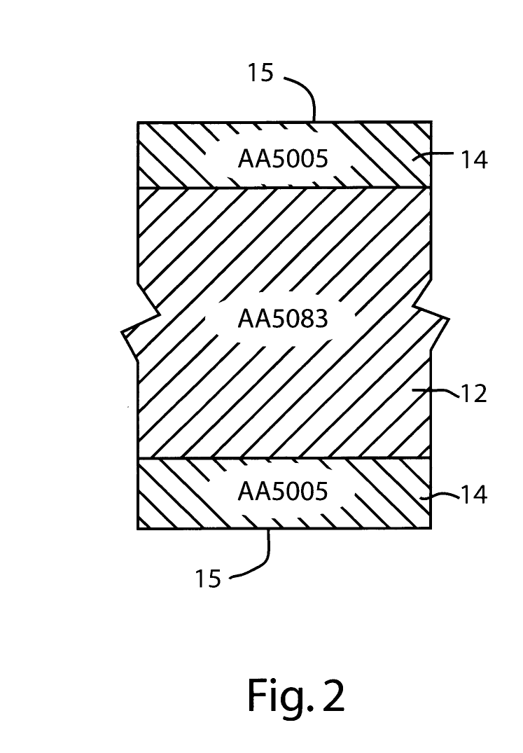

To demonstrate the exemplary embodiments, samples were produced with an outer layer of AA5005 and an AA5083 core layer as represented in FIG. 2. An ingot to was produced according to the casting method described in WO 04/112992 with two outer (clad) layers 14, one either side of the core layer 12, and then homogenized and hot rolled in a conventional manner. The structure had anodizable surfaces 15 on each face.

The hot rolled sheet was then cold rolled with an interanneal and further cold rolled to various reductions. The interanneal was performed at a gauge of 1.65 mm and a temperature of 335° C. for two hours with slow heating and cooling. The annealed sheet was subsequently rolled to 1.2, 1.0, 0.8 or 0.6 mm. These gauges correspond to reductions of 25, 37.5, 50 and 63.5%, respectively. From these, tensile specimens were prepared parallel to the rolling direction. The yield stress, ultimate tensile strength (UTS) and elongation to failure were determined for each case by conventional tensile testing.

The chemical composition of this clad package is shown in Table 2 below. Note that the Mg content in the core layer for this clad package is in the lower range for an AA5083 alloy. The clad thickness for this product was approximately 7% per side.

TABLE 2
Chemical compositions of the Product of the Example

| | Cr | Cu | Fe | Mg | Mn | Si | Ti | Zn |
|---|---|---|---|---|---|---|---|---|
| Core | 0.07 | 0.04 | 0.32 | 4.33 | 0.74 | 0.09 | 0.03 | 0.03 |
| Clad | 0.002 | 0.004 | 0.07 | 0.69 | 0.00 | 0.06 | 0.03 | 0.02 |

The results of the mechanical properties are presented in Table 3 below.

TABLE 3
Tensile properties of the product of the Example

| Gauge | Reduction (%) | YS (ksi) | UTS (ksi) | Elong. (%) |
|---|---|---|---|---|
| 1.65 | O-temper | 21.7 | 41.2 | 20.4 |
| 1.2 | 27.3 | 46.7 | 49.4 | 4.7 |
| 1 | 39.4 | 49.7 | 51.8 | 3.1 |
| 0.8 | 51.5 | 52.4 | 53.9 | 3.3 |
| 0.6 | 63.6 | 54.9 | 56.6 | 2.9 |

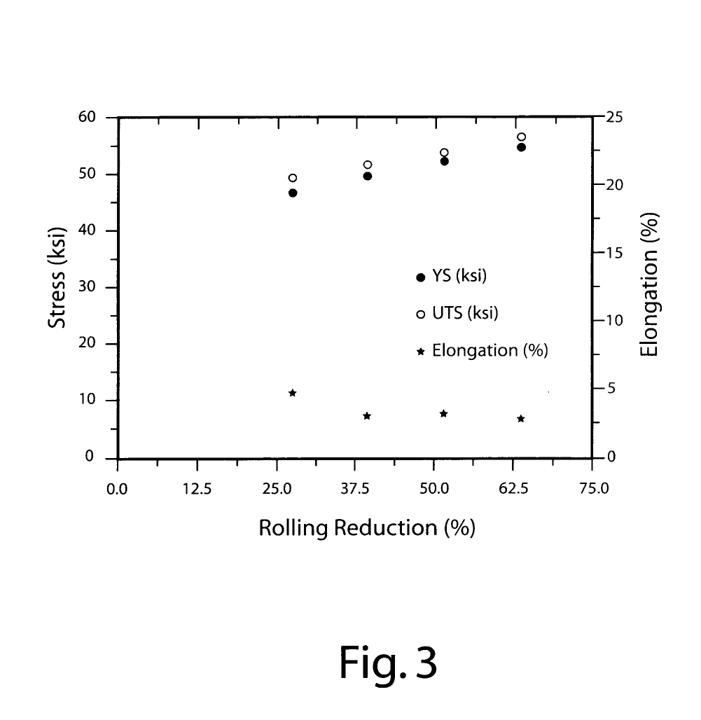

These data are also plotted in FIG. 3 of the accompanying drawings. The typical mechanical properties of a monolithic AA5005 alloy for the same purpose in the H14 or H34 temper exhibit a tensile yield strength between 15 and 19 ksi.

The data show that the work hardening rate is quite high and that a yield strength of around 43 ksi is obtainable at a rolling reduction of less than 25%. The elongations to failure also rapidly decrease with strain hardening and an elongation of no less than 8% would also be obtainable for a reduction of less than 25%.

Compared with a single alloy AA5005 product, it is possible with the exemplary embodiments to obtain a much higher yield strength with minimal cold reduction after an interanneal and also to achieve a good elongation to failure. The skilled person will recognize that it is possible to tailor the cold rolling and interanneal conditions in order to vary the final mechanical properties to suit specific design requirements.

1. An aluminum architectural sheet product comprising a composite structure having a core layer and at least one clad layer, wherein the core layer is an alloy selected from the group AA5XXX series alloys with a magnesium content greater than 3 weight %, and the at least one clad layer is selected from the group of alloys consisting of AA5005, AA5205, AA5052, AA5252 and AA5005A.

2. The product of claim 1, wherein the composite structure comprises two clad layers with one clad layer on each side of the core layer.

3. The product of claim 2, wherein the two clad layers are of the same composition.

4. The product of claim 1, wherein the core layer comprises an alloy selected from the group consisting of AA5154, AA5254, AA5654, AA5754, AA5056, AA5456, AA5556, AA5082, AA5182, AA5083, AA5383, AA5086 and AA5186.

5. The product of claim 1, wherein the core layer is AA5083.

6. The product of claim 1, wherein the at least one clad layer is AA5005.

7. An anodized sheet article comprising the product of claim 1 provided with an anodic film at an outer surface of said at least one clad layer.
